(19) United States
(12) Patent Application Publication
(10) Pub. No.: US 2008/0223731 A1
(43) Pub. Date: Sep. 18, 2008

(54) Advanced Electro-Coagulation Device And Process Of Using The Same For Wastewater Treatment

(76) Inventor: Thiam Seng Lee, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(21) Appl. No.: 12/091,059

(22) PCT Filed: Sep. 15, 2006
(86) PCT No.: PCT/SG2006/000269

§ 371 Date: Apr. 21, 2008

(30) Foreign Application Priority Data
Oct. 28, 2005 (SG) 200507332-5

(51) Int. Cl. C02F 1/461

(52) U.S. Cl. 205/761; 204/672

(57) ABSTRACT

The present invention provides an electrocoagulation device for drinking water and wastewater treatment by electro-coagulation and electro-catalytic precipitation principles. The invented device comprises a number of electrolysis cells formed by round-shaped electrode plates through which the raw water and waste water passes. A low DC voltage of 5 to 15 volts is applied to the cells. In addition, an electrode surface activator unit is provided to eliminate or minimize the passivation of the electrode plates. All types of impurities, including suspended solids, sub-micron particles, dissolved matters, dissolved minerals (including heavy metals and colloidal compounds), oil, grease, organic compounds and algae are converted to flocculants, water and carbon dioxide by the device. Micro-organisms and bacteria (pathogens) will be effectively killed at up to 99.99%. The invented device is capable of continuous operation.

### FIELD OF THE INVENTION

The present invention generally relates to a device and process for removing contaminants from wastewater by electrolysis processes, and more particularly to an advanced electro-coagulation device that comprises electro-coagulation and electro-catalytic precipitation cells, and at least one electrode surface activator unit, and a process that removes the contaminants from wastewater using the advanced electro-coagulation device in a continuous and cost-effective manner.

### BACKGROUND OF THE INVENTION

Wastewater in this application refers to any aqueous fluid that without prior treatment is not suitable for human consumption or industry application or discharge from any facility because of the existence of natural or artificial contaminants. The contaminants include organics, particulates, sub-micro particles, microorganisms such as viruses and bacteria, and dissolved metals. Wastewater is being continuously generated by nature (e.g., storm, mudslides, animals, and growth of microorganisms) and human activities (e.g., domestic consumption, and industry applications); it imposes a grave challenge to provide suitable water supply for human consumption and industry applications because of limited water reservoir on the Earth. Therefore, wastewater treatment is critical for provision of reusable water and limit of spreading of contamination from untreated discharge from wastewater-generating industries.

Electrolysis process (often referred as electrocoagulation) has been proven to be able to treat a variety of wastewater including paper pulp mill waste, metal plating, tanneries, caning factories, steel mill effluent, slaughterhouses, chromate, lead and mercury-laden effluents, domestic sewage, and radioactive materials. It has the capability of removing a large range of contaminants under a variety of conditions ranging from: suspended solids, heavy metals; petroleum products, color from dye-containing solution, aquatic humus, and defluoridation of water. The treatment provides clear, clean, odorless and reusable water.

Electrocoagulation is a complex process with a multitude of mechanisms operating synergistically to remove contaminants from wastewater. Electro-coagulation employs a pair of electrodes to neutralize small charged particles in colloidal suspension. The electrodes are usually made of aluminum or iron. When the electrodes (anode and cathode) are subjected to a specific current density, the anodes are oxidized and form metal ions (either Fe⁺², Fe⁺ or Al⁺³) in solution that react with hydroxide (OH−) anions created in the electrocoagulation process. This leads to the formation of metal hydroxide ions, either cationic or anionic species depending on the pH of the wastewater. A combination of inert anodes and metal (titanium) cathodes can also be used. The inert electrodes accomplish contaminant destabilization utilizing the transfer of electrons within the electrolyte. The transfer of electrons and formation of protons (H⁺) created in the electrocoagulation process can effectively destabilize a range of metal and organic contaminant species.

For aluminum anode, various forms of charged hydroxyl (OH⁻) and Al⁺³ species might be formed under appropriate conditions. These gelatinous hydroxyl cationic/anionic complexes can effectively destabilize contaminant particles by adsorption and charge neutralization, resulting agglomeration due to the attractive van der Wall forces and formation of stable precipitates that could then be separated by conventional separation technique. Typical chemical reactions at both the aluminium anode and cathode are shown below:

Anode:

Al₍ₛ₎→Al³⁺_{(aq)}+3e⁻(lose electrons)

Al³⁺_{(aq)}+3H₂O→Al(OH)₃+3H⁺

nAl(OH)₃→Alₙ(OH)₃ₙ

Cathode:

2H₂O+2e⁻→H2_{(g)}+2OH⁻

Al³⁺+3e⁻→Al₍ₛ₎ (gain electrons)

The electrochemical dissolution of the aluminum anode produces Al³⁺ ions which further react with OH⁻ ions (from cathode), transforming Al³⁺ ion initially into Al(OH)₃ and then into the gelatinous hydroxyl precipitate (Aln(OH)₃ₙ). Depending on the pH of the wastewater, different ionic species will also be formed in the medium such as: Al(OH)²⁺, Al₃2(OH)₂²⁺, and Al(OH)₄. At the cathode, hydrogen (H₂) gas and hydroxide (OH⁻) ions are formed from the division of H₂O and dissolved metals are reduced to their elemental state. (i.e. Al³⁺).

The electrochemical dissolution of the iron anode produces iron hydroxide, Fe(OH)ₙ where n=2 or 3. There are two proposed mechanisms for the production of the iron hydroxide. Like the gelatinous aluminum hydroxyl precipitate (Aln(OH)₃ₙ), the iron hydroxide precipitate (Fe(OH)ₙ) formed remains in the aqueous medium (stream) as a gelatinous suspension. This suspension can also remove water and wastewater contaminants either by complexation or by electrostatic attraction, followed by coagulation. The cathode is subject to scale formation, which can impair the operation of the system. Typical chemical reactions at both the iron anode and cathode are shown below:

Anode:

4Fe₍ₛ₎→Fe²⁺_{(aq)}+8e⁻(lose electrons)

4Fe²⁺_{(aq)}+10H₂O_{(I)}+O_{2(g)}→4Fe(OH)₃₍ₛ₎+8H⁺_{(aq)}

Cathode:

8H⁺_{(aq)}+8e⁻→4H_{2(g)}

Overall:

4Fe₍ₛ₎+10H₂O_{(I)}+O_{2(g)}→4Fe(OH)₃₍ₛ₎+4H_{2(g)}

Anode:

Fe₍ₛ₎→Fe²⁺_{(aq)}+2e⁻(lose electrons)

Fe²⁺_{(aq)}+2OH⁻_{(aq)}→FeOH₂₍ₛ₎

Cathode:

2H₂O_{(I)}+2e⁻→H_{2(g)}+2OH⁻_{(aq)}

Overall:

Fe₍ₛ₎+2H₂O_{(I)}→Fe(OH)₂₍ₛ₎+H_{2(g)}

A typical electrocoagulation reactor contains a series of substantially parallel electrolytic plates or electrodes through which the wastewater to be treated travels in a serpentine path while being exposed to a strong electric field or voltage. For the past twenty over years, in order to try to find a more environmentally friendly way to treat wastewater, many electrocoagulation (EC) systems were designed and built for many wastewater treatment applications. For example, US 2002/0040855 A1 discloses an apparatus for electrocoagulation treatment of industrial wastewater. However, a broad use of the EC systems is limited by unsolved technical obstacles.

The main technical obstacles affecting the efficiency and performance of EC devices include the corrosion and passivation of electrodes and the accumulation of gases in an EC device. Electrodes are easily coated with contaminants, corroded and oxidized by wastewater, thus unable to evenly distribute the ion density in wastewater. Therefore, regular cleaning and replacement of electrodes were normally required. In addition, the oxygen and hydrogen gases are gathered over time at the electrodes and not utilized fully for treating the wastewater, causing a reduction or stoppage of electrolysis action after some time. These result in higher electrical power consumption than expected, slower separation of flocculants from the water at the output, higher percentage of sludge and lower percentage of floating flocculants due to inefficient use of hydrogen gas, and required post-treatment of sludge.

Attempts have been made to address the problem of passivation of electrodes during the electrocoagulation process by constructing self-cleaning electrolytic cells. For example, US 2003/0222030 A1 discloses an electro-coagulation treatment system with an electrolytic cell including an anode and a helical cathode. It claims that the provision of a helical cathode in the form of a helically wound coil of a wire or rod of circular cross section provides an arrangement in which the cell is automatically self-cleaning in that the coagulated precipitates are carried from the cell by the flow of the water. However, the construction of such a helical cathode is a challenge and increases its cost. In addition, CN 01108767.6 discloses an EC device with a wiper to remove any deposits from the surfaces of electrodes. However, the wiper is in firm contact with surfaces of electrodes, and this causes unnecessary wearing out of the electrodes.

Attempts also have been made to reduce the sludge by increasing the flocculants. For example, U.S. Pat. No. 6,719,894 discloses an apparatus for treating organics, particulates and metal contaminates in a waste fluid. The apparatus has a pressurizing means for pressurizing waste fluid to be treated in the reactor vessel so that water, organics, particulates and metal contaminants form dissolved gases and form precipitate particles in the pressurized waste fluid. When the pressure of the treated waste fluid is reduced, dissolved gases evolve from the waste fluid causing said precipitate particles to float to a fluid surface for removal. However, the introduction of pressure complicates the system.

### SUMMARY OF THE INVENTION

Therefore, there is an imperative need for an electrocoagulation device and method that can treat wastewater in a continuous and cost-effective manner.

In one aspect, the present invention provides an electrocoagulation (EC) device for treating aqueous fluids with contaminants, where the EC device comprises a plurality of anode electrode plates and cathode electrode plates, wherein the anode and cathode electrode plates are arranged alternatively so that one anode plate and one cathode plate form an electrolytic cell with which the aqueous fluids undergo electrochemical reactions so that the contaminants will become gelatinous flocculants and sludge at the end of the reactions, and wherein the electrode plates are substantially parallel metallic electrolytic plates disposed substantially parallel to each other; at least two bus-bars, where one bus-bar is connected to the anodes, and another bus-bar to the cathodes; an electrode surface activator (ESA) unit with a plurality of wipers, wherein each wiper is disposed between two adjacent electrode plates, and wherein the wipers are lightly in touch or in close proximity of the surfaces of the electrode plates when the wipers are in motion, and wherein the wipers in motion keeps the surfaces of the electrode plates from passivation; and a sealed chamber within which the electrode plates and ESA unit are disposed.

In one embodiment, in the EC device, the electrolytic plates are fabricated from material selected from the group consisting of iron, titanium, platinum, steel, aluminum, copper, carbon, metal-impregnated plastics, ceramics or a mixture thereof. In another embodiment; in the EC device, the electrolytic plates are made of aluminum. In another embodiment, in the EC device, the electrolytic plates are made of iron. In yet another embodiment, each of the electrolytic plates has a hole allowing the aqueous fluids to pass through from one cell to another; wherein the holes on two adjacent plates are opposite cross the center. In still another embodiment, all the anode electrode plates are connected to one bus-bar and connected to the positive terminal of a DC power supply; and wherein all the cathode electrode plates are connected to another bus-bar and connected to the negative terminal of the DC power supply. In yet another embodiment, the bus-bar is made of copper or copper coated or plated with tin, silver or gold.

In another embodiment, the ESA unit further comprises a wiper driver shaft, a speed reduction gearbox, an electric motor for driving the wiper drive shaft via the speed reduction gearbox, a bearing with seal holding the wiper drive shaft in place and allowing smooth movement and water tight sealing, and a plurality of wiper spacers for insulating the wiper shaft from the electrode plates when it penetrates the plates; wherein the wiper drive shaft is disposed through the centers of the electrode plates. In yet another embodiment, the wiper blade has a cylindrical shape. In another embodiment, the wiper blade has a partial cylindrical shape with two straight sides. In another embodiment, the wiper blade has a thin blade protrusion throughout the length of the blade. In another embodiment, the wiper blade has brushes (toothbrush style) attached throughout the length of the blade; wherein the wiper blade further comprises a plurality of holes on its two surfaces facing the plate surfaces to accommodate fibers to form a brush on each side.

In another embodiment, the sealed chamber is formed by two end bracket/stand, two end insulators, a plurality of electrode plates and a plurality of electrode spacers with O-rings so that the reactions can be carried in a sealed environment, preventing leakage of liquid and gases. In another embodiment, the EC device further comprises an inlet and an outlet for allowing the EC device to get the aqueous fluids for treatment and exit the treated aqueous fluids.

In another embodiment, all anode electrode plates are sacrificial so as to form an electro-coagulation device. In another embodiment, all anode electrode plates are not sacrificial so as to form an electro-catalytic device. In another embodiment, the anode electrode plates are made of carbon. In another embodiment, at least one anode electrode plate is different from the rest (e.g., sacrificial vs non-sacrificial) so as to form a hybrid EC device.

In another embodiment, the aqueous fluids with contaminants are any aqueous solution that needs to be treated before its use. In another embodiment, the contaminants include organics, metals, microorganisms, and sub-micro particles.

In another aspect, the present invention provides an electrocogulation system for treating aqueous fluids with contaminants, where the system comprises a pre-treatment unit for receiving the aqueous fluids to be treated; a post-treatment unit for receiving the aqueous fluids being treated; and a plurality of anode electrode plates and cathode electrode plates, wherein the anode and cathode electrode plates are arranged alternatively so that one anode plate and one cathode plate form an electrolytic cell with which the aqueous fluids undergo electrochemical reactions so that the contaminants will become gelatinous flocculants and sludge at the end of the reactions, and wherein the electrode plates are substantially parallel metallic electrolytic plates disposed substantially parallel to each other; at least two bus-bars, where one bus-bar is connected to the anodes, and another bus-bar to the cathodes; an electrode surface activator (ESA) unit with a plurality of wipers, wherein each wiper is disposed between two adjacent electrode plates, and wherein the wipers are lightly in touch or in close proximity of the surfaces of the electrode plates when the wipers are in motion, and wherein the wipers in motion keeps the surfaces of the electrode plates from passivation; and a sealed chamber within which the electrode plates and ESA unit are disposed.

In yet another aspect, the present invention provides a process for treating aqueous fluids with contaminants using the device and system provided herein.

One advantage of the present invention is that the treatment of wastewater becomes continuous operation with high efficiency.

Another advantage of the present invention is that both electro-coagulation and electro-catalytic precipitation cells can be built into one device, and cells can be configured to treat all types of pollutants in wastewater in one pass.

Another advantage of the present invention is that electrodes are activated at all times by an electrode surface activator unit, ensuring high efficient electrochemical reaction. The electrode surface activator unit keeps the electrode surfaces clean, reduces metal depletion and controls the amount of passivation as required by the process.

Another advantage of the present invention is that the processing speed of waste water is 2 to 5 times faster than EC machines made by others.

Another advantage of the present invention is that the separation of flocculants from water is 2 to 5 times faster than EC machines made by others.

Another advantage of the present invention is that flocculants floats due to efficient utilization of hydrogen and oxygen gas given off by the EC cell.

Another advantage of the present invention is that very much lower electric power consumption than EC machine made by others.

Another advantage of the present invention is that any odor and color of the processed water is removed or greatly reduced.

Another advantage of the present invention is that pathogens (bacteria and micro-organisms) are killed or removed by up to 99.99%.

The objectives and other advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is a block diagram illustrating the electrocoagulation system in accordance with one embodiment of the present invention.

FIG. 2 shows an illustrative cross-section view of the electrocoagulation device in accordance with one embodiment of the present invention.

FIG. 3 shows a plan view of the outlet end of the EC device in accordance with one embodiment of the present invention.

FIG. 4 shows a plan view of the inlet end of the EC device in accordance with one embodiment of the present invention.

FIG. 5 shows a schematic cross-section view of the configurations of the electrode plates 11, and the wipers 20 and wiper drive shaft 21 of the ESA unit within the sealed chamber of the EC device in accordance with one embodiment of the present invention.

FIG. 6 shows a schematic cross-section view of a first type of electrolytic cell (A-cell) in accordance with one embodiment of the present invention.

FIG. 7 shows a schematic cross-section view of a second type of electrolytic cell (B-cell) in accordance with one embodiment of the present invention.

FIG. 8 shows a partial schematic cross-section view of the configuration among the electrode plates and wiper in accordance with one embodiment of the present invention.

FIG. 9 shows an illustrative view of a wiper with two blades in accordance with one embodiment of the present invention.

FIG. 10 shows an illustrative view of a wiper with four blades in accordance with one embodiment of the present invention.

FIG. 11A and FIG. 11B shows an illustrative cross-section view and plan view respectively of the wiper in accordance with one embodiment of the present invention.

FIG. 12A and FIG. 12B shows an illustrative cross-section view and plan view respectively of the wiper in accordance with another embodiment of the present invention.

FIG. 13A and FIG. 13B shows an illustrative cross-section view and plan view respectively of the wiper in accordance with one embodiment of the present invention.

FIG. 14A and FIG. 14B shows an illustrative cross-section view and plan view respectively of the wiper in accordance with one embodiment of the present invention.

FIG. 15 shows a schematic view of the basic electrical connections among the electrolytic plates, bus-bars, wiper motor and power supplies in accordance with one embodiment of the present invention.

FIG. 16 shows an illustrative view of the process of wastewater flow through and within the EC device in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

While the description will relate to many specific elements and techniques in order to better illustrate the principles of the present invention, it is to be appreciated that the present invention is not limited to the specific descriptions. The present invention can be practiced with variations to any specific elements and techniques without departing from the principles of the present invention. At the same time, many details and specifics that their omissions will not affect the practices of the present invention will be omitted from the description in order not to obscure the principles of the present invention.

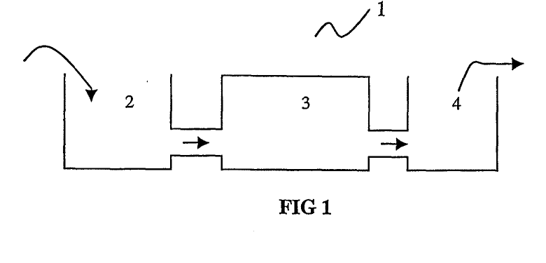

Now referring to FIG. 1, there is provided an electrocoagulation (EC) system in accordance with one embodiment of the present invention. The EC system 1 comprises a pretreatment unit 2, an electrocoagulation (EC) device 3, and a post-treatment unit 4. The pre-treatment unit 2 includes at least one tank for receiving wastewater to be treated and input pipes and pumps and valves for controlling the speed and volume wastewater being introduced into the pre-treatment unit and being pumped out the pre-treatment unit and into the electrocoagulation device. The pre-treatment unit may pre-filter the wastewater to remove big particles and/or change the pH and compositions of the wastewater by adding the correct type and amount of chemicals so as to improve the efficiency. The EC device 3 performs the electrolytic treatment, where the device and its operation will be detailed hereinafter. The post-treatment unit 4 includes at least one tank for receiving the affluent from the EC device. The post-treatment unit separates the clean water from the flocculants and sludge so that the flocculants are collected from the surface and the sludge is collected at the bottom for further treatment. Dosing small amount of polymer will make the flocculants bind and float more effectively. The separation can employ any known methods including filtering and precipitating. The pre-treatment and post-treatment can be done using any known methods. Thus, no further details will be provided herein.

In one aspect of the present invention, there is provided an EC device that comprises a plurality of electrolytic cells and an electrode surface activation (ESA) unit, where the EC device can treat a wide range of wastewater in a continuous and cost-effective manner.

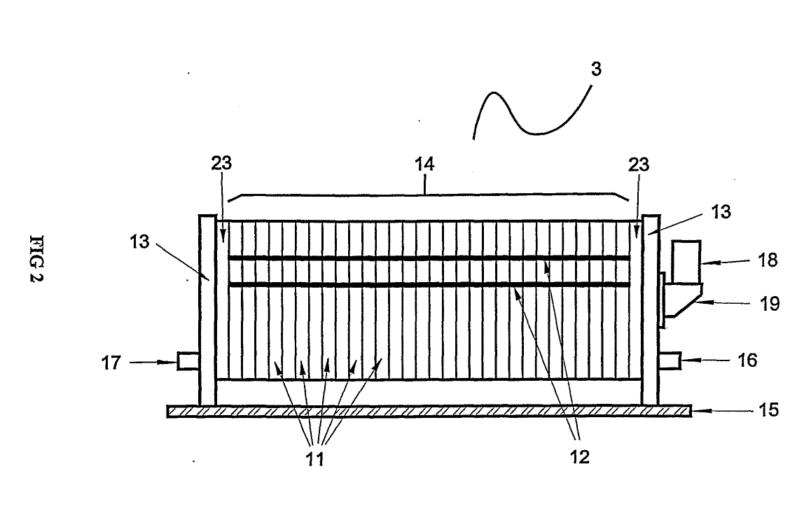

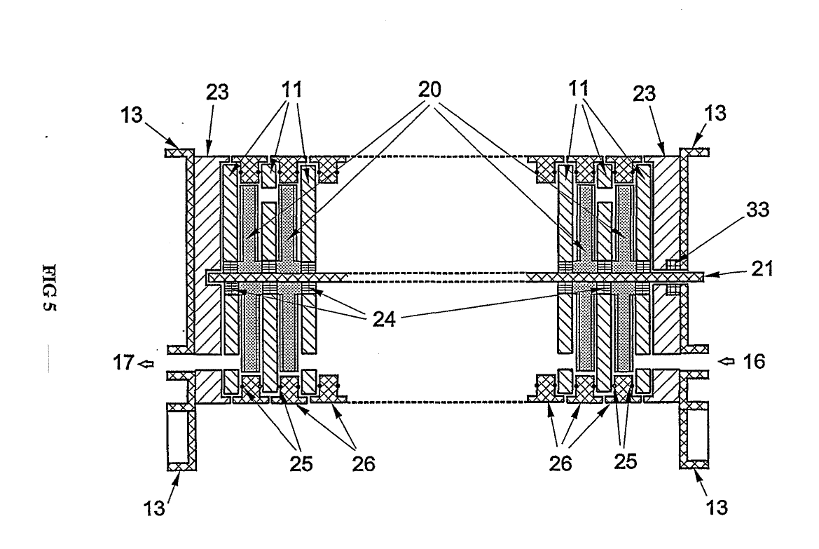

Now referring to FIG. 2, there is provided an illustrative side view of the EC device in accordance with one embodiment of the present invention. The EC device 3 comprises a plurality of anode and cathode electrode plates 11, two bus-bars 12 for electrical connections to anodes and cathodes, two end bracket/stand 13, end insulators 23, cell stack 14, base frame 15, inlet (inflow) 16, outlet (outflow) 17, and an ESA unit including a wiper motor 18, a reduction gearbox 19, a plurality of wipers 20 (first shown in FIG. 5), and wiper drive shaft 21 (first shown in FIG. 5). The cell stack 14, the end insulators 23 and the two end bracket/stand 13 form a sealed chamber within which wastewater is being treated. The interior of the sealed chamber is of cylindrical shape for circular electrode plates in one embodiment. The interior may be in any other shapes that are suitable for specific applications. The exterior of the sealed chamber may be of polygon shapes for each handling. It is to be noted that the shapes are not critical for the practice of the present invention. The gap or space between the anode and cathode electrode plates depends on the type and capacity of wastewater to be treated; it should be easily determined by those skilled in the art. The sealed chamber is disposed onto the base frame 15. The cell stack, end bracket/stand, and base frame may be made of any suitable material by any known techniques. In certain embodiments, the suitable materials include stainless steel, iron, engineering grade plastics, or ceramics.

The plurality of anode and cathode electrode plates 11 are substantially parallel metallic electrolytic plates disposed substantially parallel to each other alternatively within the sealed chamber. The electrolytic plates may be fabricated from material that may sacrifice or donate ions in an electrolysis process. Preferably, the plates may be fabricated from iron, titanium, platinum, steel, aluminum, copper, carbon, metal-impregnated plastics, ceramics or the like. In one embodiment, the electrolytic plates are made of aluminum. In another embodiment, the electrolytic plates are made of iron. The two bus-bars 12 connect the electrolytic plates alternatively so that every two adjacent electrolytic plates form an electrolytic cell. All the anode electrode plates are connected to one bus-bar and connected to the positive terminal of a DC power supply. All the cathode electrode plates are connected to another bus-bar and connected to the negative terminal of the DC power supply. In one embodiment, the bus-bar is made of copper or copper coated or plated with tin, silver or gold. The bus-bar may be also made of other metals including gold, silver, or the like. As shown in FIG. 2, in one preferred embodiment, the interlaced electrolytic cells with the electrode plates are mounted vertically and the EC device is mounted in a horizontal position. The horizontal orientation with vertical electrode plates reduces the accumulation of bubbles on the surfaces of the electrode plates. It is to be appreciated that other orientations like vertical one may also be used in the present invention.

While there are thirty electrolytic cells shown in FIG. 2, the number of electrolytic cells within one EC device will vary according to specific applications. In one embodiment, the EC device has sufficient numbers of cells to allow the wastewater to stay in the EC device for about 60 to 120 seconds. It is evident that the length of time for wastewater to stay in the EC will depend on multiple factors including the number of electrolytic cells and flow rate. In addition, the distance between two adjacent plates is determined by multiple factors such as power supply and the types of wastewater to be treated. It is in the theory of electrocoagulation that the closer the distance between the electrode plates, the lower the DC voltage is required for electrolysis reaction. In one preferred embodiment, when the DC power supply is in the range of 5 to 15 voltages, the distance between two plates is about 5 to 15 mm.

The inlet (inflow) 16 takes wastewater from the pre-treatment unit 2. The outlet (outflow) 17 vents the treated wastewater into the post-treatment unit 4. Suitable pumps and valves can be used to control the flow. In one embodiment, the inlet pipe is at one end and the outlet pipe at the other end. It is evident that both the inlet and outlet can be configured at the same end as long as the inflow will not mix with the outflow before the inflow is fully treated within the EC device. In one embodiment, both of the inlet pipe and outlet pipe can have threaded or flanged connection, depending on the piping requirements.

As for the ESA unit, the wiper motor is a small motor that drives the wiper drive shaft 21 via the speed reduction gearbox 19.

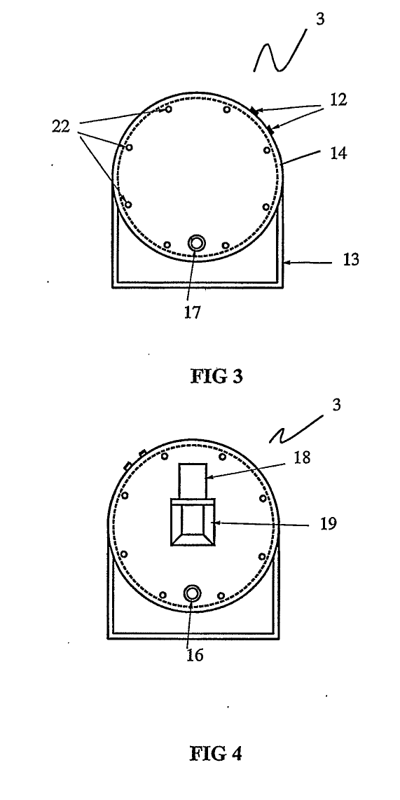

Now referring to FIG. 3, there is provided a plan view of the outlet end of the EC device in accordance with one embodiment of the present invention. The electrode plates are fastened along their peripherals. The fastening means 22 include through-rods and nuts. In addition, the bus-bars 12 can be located within any suitable points on the electrode plates. FIG. 4 shows a plan view of the inlet end of the EC device in accordance with one embodiment of the present invention.

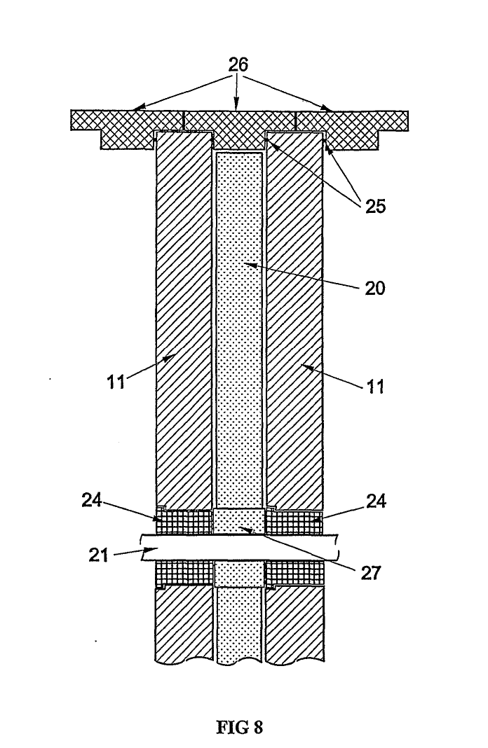

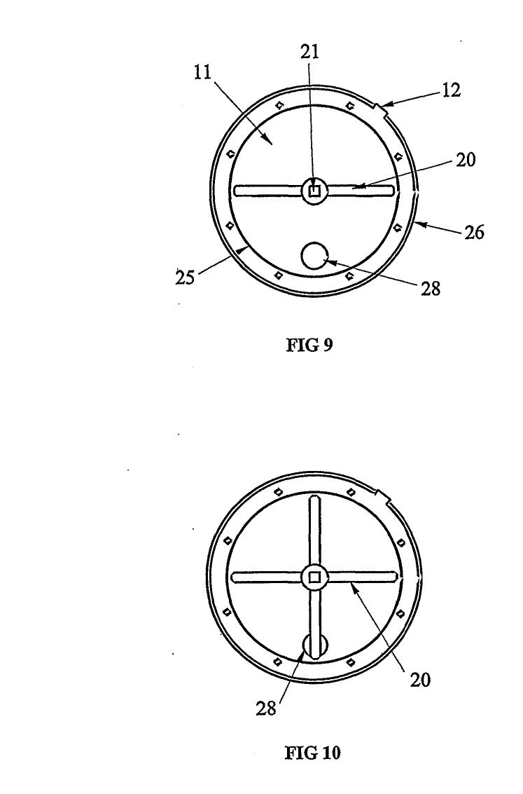

Now referring to FIG. 5, there is provided a schematic cross-section view of the configurations of the electrode plates 11, and the wipers 20 and wiper drive shaft 21 of the ESA unit within the sealed chamber of the EC device in accordance with one embodiment of the present invention. The electrode plates 11 are insulated from each other by electrode plate spacers 26 and sealed with O-rings 25. Both ends of the cell stack 14 are insulated from the two end bracket/stand 13 by the end insulators 23. The end insulators and electrode plate spacers may be made of any suitable insulating materials. In one embodiment, they are made of plastics. Each electrode plate has a flow hole 28 (shown in FIG. 9) at its peripheral allowing the wastewater to flow. In one embodiment, in order to increase the travel distance of the wastewater within the EC device, the holes on two adjacent plates are opposite to each other. It is evident that the holes can be constructed in other shape, size or configuration according to specific requirements. In one embodiment, the flow holes 28 are round in shape. The wipers are disposed between every two adjacent electrode plates. All wipers 20 are connected to the wiper drive shaft 21. In one embodiment, in order to obtain the best balance, the wiper drive shaft 21 is located within the center of the sealed chamber and the wipers. The wiper drive shaft 21 is insulated from the electrode plates by the wiper drive spacers. A bearing with seal 33 holds the wiper shaft in place, allowing smooth movement and water tight sealing.

It is convenient to use identical electrolytic cells in one EC device, but it may not be able to treat as many contaminants as desired. The inventors of the present invention discovered that the inclusion of two kinds of electrolytic cells within one EC device broadened its capabilities of treating different contaminants. Therefore, in one aspect of the present invention, there is provided two kinds of electrolytic cells that can be employed in any EC devices, wherein the two kinds of electrolytic cells are based on two different operation principles.

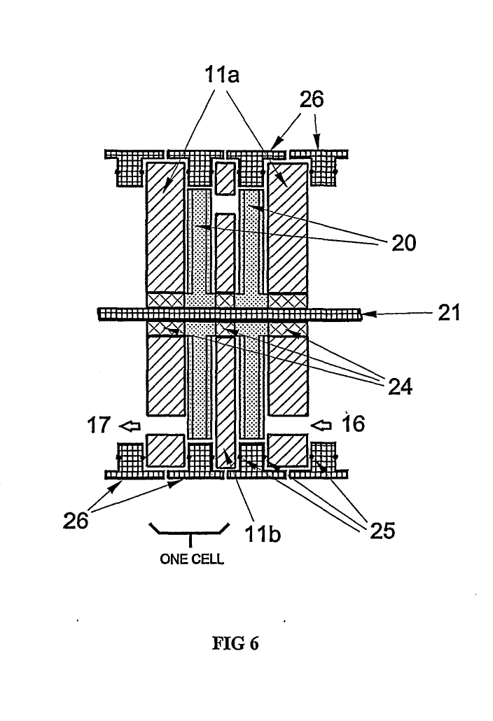

Now referring to FIG. 6, there is provided a schematic cross-section view of a first type of electrolytic cell (A-cell) in accordance with one embodiment of the present invention. The A-cell is an electro-coagulation cell using principle of sacrificial anode to create flocculants to remove organic solids, minerals or metal from the wastewater. The anode 11a is usually made of aluminum and is thicker than that of the cathode 11b which is made of iron. In combination with the wipers (described in detail hereinafter) of the present invention, it has been demonstrated that the degree of surface passivation could be controlled and the electrode metal depletion was reduced by up to 80% as compared to other EC device. The small amount of metal content in the flocculants released by the sacrificial electrodes is processed by the B-cell (detailed next) into harmless compounds.

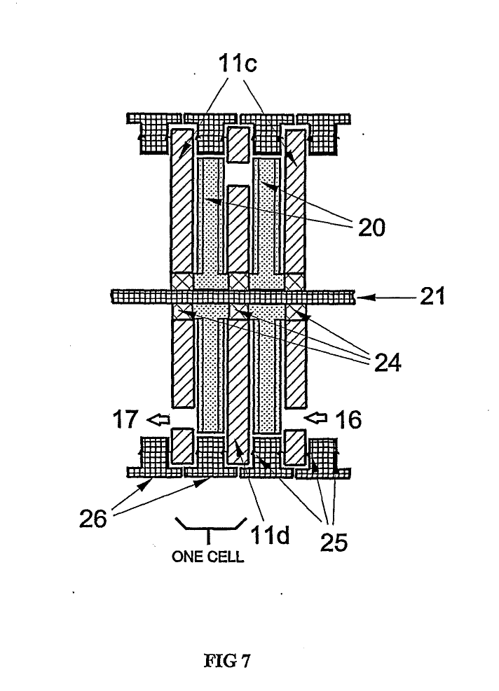

Now referring to FIG. 7, there is provided a schematic cross-section view of a second type of electrolytic cell (B-cell) in accordance with one embodiment of the present invention. B-cell is an electro-catalytic cell using electro-catalytic precipitation principles that do not cause electrode metal depletion. It uses electrolytic oxidation to reduce chemical compounds and oxidize metals in wastewater. This oxidation process reduces organic solids to a liquid, and a liquid into gas, usually to H₂O and CO₂. Precipitation is the oxidation/reduction of metals to form metal mineral compounds form into flocculants. Hydroxyl radicals (OH) and ozone (O₃) are produced in each cell. Both anode 11c and cathode 11d electrodes are of the same thickness, and have the same thickness as the cathode of the A-cell. The B-cell can treat some pollutants which the A-cell cannot and vice-versa. The anode 11c is usually made of carbon and cathode 11d made of iron, same as 11b. The cathode 11d can also be the shared cathode of an A-cell. By using different metal, electrically conductive material like carbon or coating the surfaces of the electrodes with metal oxides, it is possible to treat many impurities or pollutants that the A-cell cannot.

Both types of cells have its own unique functions and are complementary to achieve a complete wastewater treatment process. Depending on the type of wastewater to be treated, the EC device can be configured with a combination of A-cells and B-cells. The two types of cell can be placed alternately with more of one type, but the last one should be a B-cell in order to remove any metal present in the output flocculants.

As discussed above, electrode plate passivation during the electrocoagulation process causes many problems. Current designs by others for minimizing the plate passivation have their limitations one way or the other. Therefore, in another aspect of the present invention, there is provided an ESA unit with new wiper designs that overcome the shortcomings of the prior art.

The ESA unit comprises a wiper motor 18, a reduction gearbox 19, a plurality of wipers 20, a plurality of spacers 24, wiper drive shaft 21 and bearing with seal 33. Now the description is focused on the wipers. In reference to FIG. 8, there is provided a partial schematic cross-section view of the configuration among the electrode plates and wiper in accordance with one embodiment of the present invention. In one embodiment, each wiper in a cell consists of two blades as shown in FIG. 9. In another embodiment, each wiper in a cell consists of four blades as shown in FIG. 10. The blades are designed and made in such a way that it only touch the electrode surfaces very lightly or do not touch at all. Using hydraulic operation principles, the rotating blades create hydraulic cleaning action of the electrode surfaces and turbulence of the liquid inside the cell. With the ESA unit, it has been demonstrated that the metal depletion of sacrificial electrodes was reduced by up to 90% of the prior art designs. The amount of passivation of the electrode surfaces can be reduced or controlled.

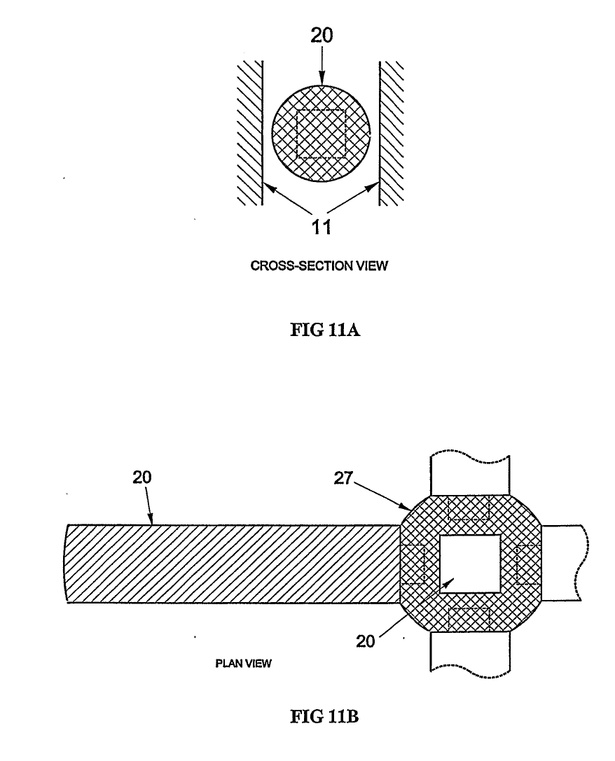

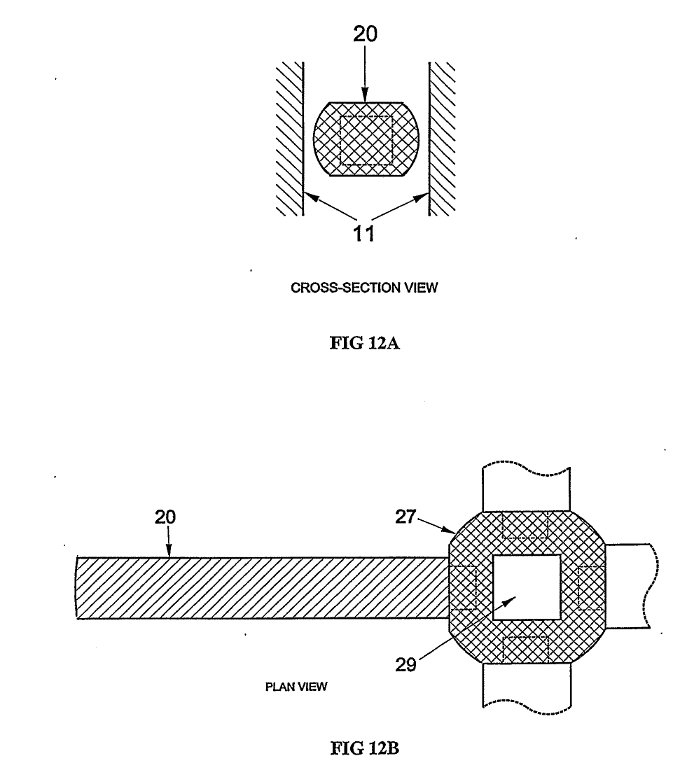

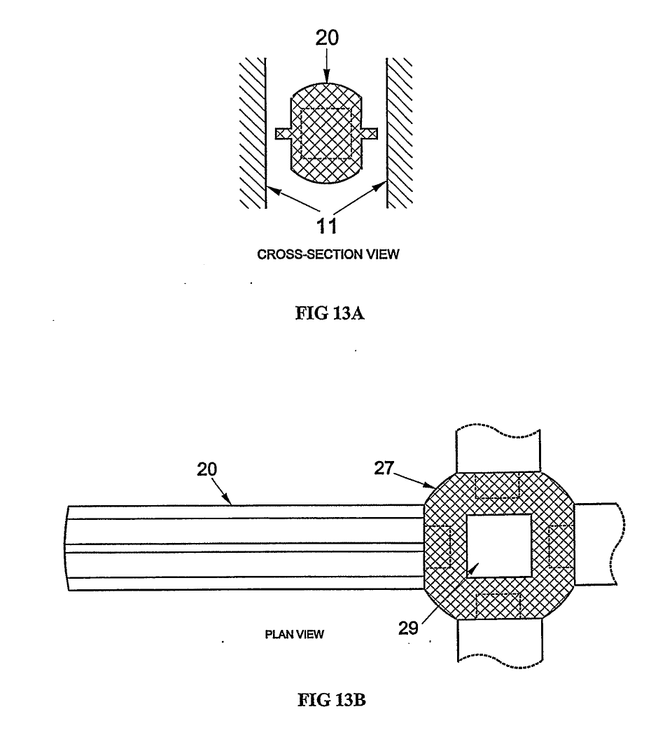

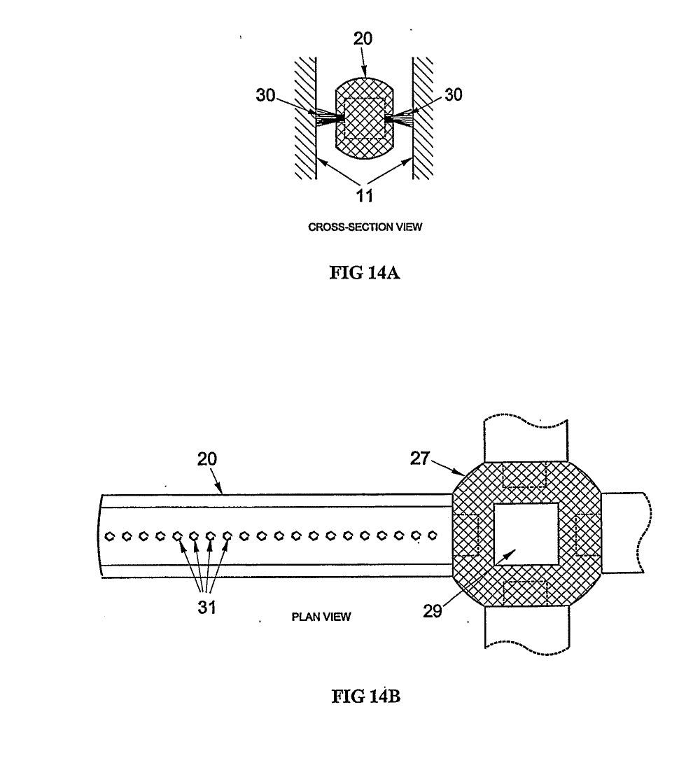

The shape and configuration of the blades of the wiper can be varied with specific applications. It is to be appreciated that different blades to be discussed herein can be combined for use in one EC device. FIG. 11A and FIG. 11B shows an illustrative cross-section view and plan view respectively of the wiper in accordance with one embodiment of the present invention. The blade as shown in FIG. 11A and FIG. 11B has a cylindrical shape. The blade is inserted into the wiper center piece 27 and the wiper center piece has a wiper drive shaft hole 29 for accommodating the wiper drive shaft. FIG. 12A and FIG. 12B shows an illustrative cross-section view and plan view respectively of the wiper in accordance with another embodiment of the present invention. The blade as shown in FIG. 12A and FIG. 12B has a partial cylindrical shape with two straight sides. FIG. 13A and FIG. 13B shows an illustrative cross-section view and plan view respectively of the wiper in accordance with one embodiment of the present invention. The blade as shown in FIG. 13A and FIG. 13B has a thin blade protrusion throughout the length of the blade. FIG. 14A and FIG. 14B shows an illustrative cross-section view and plan view respectively of the wiper in accordance with one embodiment of the present invention. The blade as shown in FIG. 14A and FIG. 14B has brushes (toothbrush style) attached throughout the length of the blade. In this design, the blade has a plurality of holes 31 for accommodating suitable fibers to form a gentle or hard brush 30. The brush can be made of material like those used on toothbrush or any suitable material. In one embodiment, the brush is made of nylon. Without wish to be bound by any specific theory or explanation, it is believed that the hydraulic cleaning and good turbulence effects result from the close proximity of the wipers to the surfaces of the electrode plates. In one preferred embodiment, the gap between the wiper and the surfaces of the electrode plates is 0.5 mm at maximum.

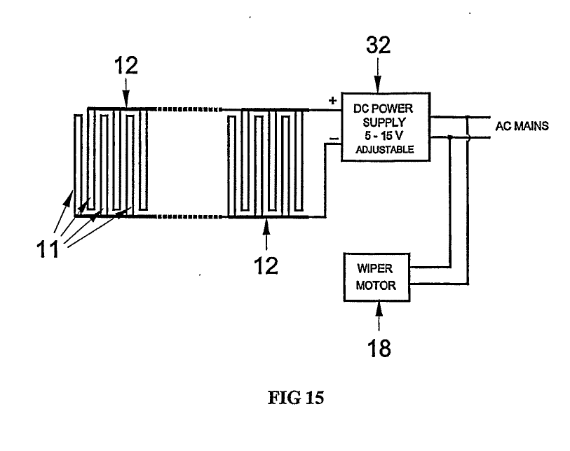

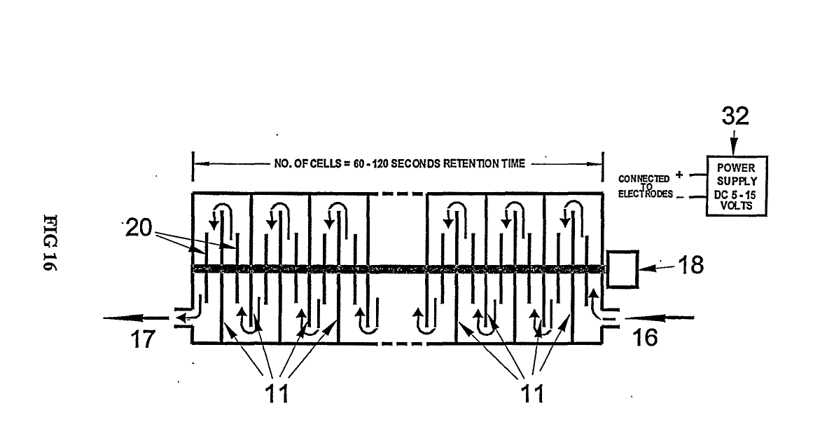

Now referring to FIG. 15, there is provided a schematic view of basis electrical connections in accordance with one embodiment of the present invention. The AC power supply is converted into adjustable 5 to 15 volts DC by a suitable DC power supply unit 32 for providing low voltage direct current electrical power to the electrolytic cells via the bus-bars. The wiper motor is also connected to the AC power supply. The necessary controls are not shown.

Now referring to FIG. 1 and FIG. 16, there is provided a brief description of a process of using the EC device for wastewater treatment in accordance with one embodiment of the present invention. The pre-treatment unit receives the contaminated water, allowing a pump to draw the liquid from the pre-treatment unit at the desired flow rate required by the EC device to function properly. After the wastewater is introduced into the sealed chamber of the EC device via the inlet 16, the wastewater meanders through the electrolytic plates via the holes in the plates (as shown by the u-turn arrows) and is under the influence of the electromotive force from the electrical current supplied to the metallic electrolytic plates by the power supply. The wipers driven by the wiper motor will continuously clean the surfaces of the electrolytic plates, mix the ions thoroughly to enable efficient electrochemical reactions, and at the same time move the gases produced in the EC process to contact with the gelatinous precipitations so that the trapped gases within the precipitations will make the precipitations into floating flocculants, but not sludge when the wastewater exits the EC device. The treated wastewater exiting the reaction chamber flows directly into the post-treatment unit. The post-treatment unit is preferably to be dosed by small amount of suitable polymer to make the flocculants float faster so as to reduce cost in removable of the flocculants. The flocculants are also quite dry and required less efforts and cost in de-watering process.

This invention may include a method further improving efficiency of the EC device. This method is to implement automatic dosing of one or more chemical compounds to adjust the pH and increase the ORP of some type wastewater in order to increase the treatment efficiency. A chemical compound such as poly aluminum chloride, ferrous sulfate and ferrite chloride can be added to the incoming wastewater at about 15 grams to one ton of wastewater. Other chemicals can be used provided they are not poisonous or give harmful residues in the processed water. It will also have the effect of reducing metal depletion of the electrodes. For processing of less polluted wastewater chemical dosing may not be required.

Depending on the chemical nature of the wastewater it may be necessary to pre-treat the wastewater prior to its passing through the electrocoagulation process. Preferably, the pre-treatment processes involves removal of large sized suspended solids and adjusting the pH and/or ORP of the wastewater.

This invention is the EC device with its associated DC power supply. For applications, it is built into a system that can consist of one or many (array) units connected in parallel in order to increase the processing flow/capacity. The system may consist of pumps, pre-treatment and post-treatment chemical dosing systems, automation control system and pipe-works.

The amount of voltage and current required depends on the volume of wastewater to be processed, the type and concentration of contaminants, and the physical size of the EC device.

While the foregoing has presented descriptions of certain preferred embodiments of the present invention, it is to be understood that these descriptions are presented by way of example only and are not intended to limit the scope of the present invention. It is expected that others skilled in the art will perceive variations which, while differing from the foregoing, do not depart from the spirit and scope of the invention as herein described and claimed.

What is claimed is:

1. An electrocoagulation device for treating aqueous fluids with contaminants, comprising:
a plurality of anode electrode plates and cathode electrode plates, wherein the anode and cathode electrode plates are arranged alternatively so that one anode plate and one cathode plate form an electrolytic cell with which the aqueous fluids undergo electrochemical reactions so that the contaminants will become gelatinous flocculants and sludge at the end of the reactions, and wherein the electrode plates are substantially parallel metallic electrolytic plates disposed substantially parallel to each other;
at least two bus-bars, where one bus-bar is connected to the anodes, and another bus-bar to the cathodes;
an electrode surface activator (ESA) unit having a driver shaft, and a plurality of wipers mounted thereon, wherein each wiper is disposed between two adjacent electrode plates, wherein the wipers are lightly in touch or in close proximity of the surfaces of the electrode plates, and wherein the driver shaft is operable to rotate the wipers for generating hydraulic flow against the surfaces of the electrode plates so as to remove or minimize contaminant deposition; and
a sealed chamber within which the electrode plates and ESA unit are disposed.

2. The electrocoagulation device of claim 1, wherein the electrolytic plates are fabricated from material selected from the group consisting of iron, titanium, platinum, steel, aluminum, copper, carbon, metal-impregnated plastics, ceramics or a mixture thereof.

3. The electrocoagulation device of claim 2, wherein the electrolytic plates are made of aluminum.

4. The electrocoagulation device of claim 2, wherein the electrolytic plates are made of iron.

5. The electrocoagulation device of claim 1, wherein each of the electrolytic plates has a hole allowing the aqueous fluids to pass through from one cell to another; wherein the holes on two adjacent plates are opposite cross the center.

6. The electrocoagulation device of claim 1, wherein all the anode electrode plates are connected to one bus-bar and connected to the positive terminal of a DC power supply; and wherein all the cathode electrode plates are connected to another bus-bar and connected to the negative terminal of the DC power supply.

7. The electrocoagulation device of claim 1, wherein the bus-bar is made of copper or copper coated or plated with tin, silver or gold.

8. The electrocoagulation device of claim 1, wherein the ESA unit further comprises:
a speed reduction gearbox;
an electric motor for driving the wiper drive shaft via the speed reduction gearbox;
a bearing with seal for holding the wiper drive shaft in place and allowing smooth movement and water tight sealing; and
a plurality of wiper spacers for insulating the wiper shaft from the electrode plates when the driver shaft penetrates the electrode plates, wherein the driver shaft is disposed through the centers of the electrode plates.

9. The electrocoagulation device of claim 1, wherein the wiper blade has a cylindrical shape.

10. The electrocoagulation device of claim 1, wherein the wiper blade has a partial cylindrical shape with two straight sides.

11. The electrocoagulation device of claim 1, wherein the wiper blade has a thin blade protrusion throughout the length of the blade.

12. The electrocoagulation device of claim 1, wherein the wiper blade has brushes (toothbrush style) attached throughout the length of the blade; wherein the wiper blade further comprises a plurality of holes on its two surfaces facing the plate surfaces to accommodate fibers to form a brush on each side.

13. The electrocoagulation device of claim 1, wherein the sealed chamber is formed by two end bracket/stand, two end insulators, a plurality of electrode plates and a plurality of electrode spacers with O-rings so that the reactions can be carried in a sealed environment, preventing leakage of liquid and gases.

14. The electrocoagulation device of claim 1, further comprises an inlet and an outlet for allowing the EC device to get the aqueous fluids for treatment and exit the treated aqueous fluids.

15. The electrocoagulation device of claim 1, wherein all anode electrode plates are sacrificial so as to form an electro-coagulation device.

16. The electrocoagulation device of claim 1, wherein all anode electrode plates are not sacrificial so as to form an electro-catalytic device.

17. The electrocoagulation device of claim 16, wherein the anode electrode plates are made of carbon.

18. The electrocoagulation device of claim 1, wherein at least one anode electrode plate is different from the rest (e.g., sacrificial vs non-sacrificial) so as to form a hybrid EC device.

19. The electrocoagulation device of claim 1, wherein the aqueous fluids with contaminants are any aqueous solution that needs to be treated before its use.

20. The electrocoagulation device of claim 1, wherein the contaminants include organics, metals, microorganisms, and sub-micro particles.

21. The electrocoagulation device of claim 1, wherein the electrode plates are mounted vertically within the sealed chamber when the device is mounted horizontally.

22. The electrocoagulation device of claim 1, wherein the electrode plates are mounted horizontally within the sealed chamber when the device is mounted vertically.

23. An electrocogulation system for treating aqueous fluids with contaminants, comprising:
a pre-treatment unit for receiving the aqueous fluids to be treated;
a post-treatment unit for receiving the aqueous fluids being treated;
a plurality of anode electrode plates and cathode electrode plates, wherein the anode and cathode electrode plates are arranged alternatively so that one anode plate and one cathode plate form an electrolytic cell with which the aqueous fluids undergo electrochemical reactions so that the contaminants will become gelatinous flocculants and sludge at the end of the reactions, and wherein the electrode plates are substantially parallel metallic electrolytic plates disposed substantially parallel to each other;
at least two bus-bars, where one bus-bar is connected to the anodes, and another bus-bar to the cathodes;
an electrode surface activator (ESA) unit having a driver shaft, and a plurality of wipers mounted thereon, wherein each wiper is disposed between two adjacent electrode plates, wherein the wipers are lightly in touch or in close proximity of the surfaces of the electrode plates, and wherein the driver shaft is operable to rotate the wipers for generating hydraulic flow against the surfaces of the electrode plates so as to remove or minimize contaminant deposition; and
a sealed chamber within which the electrode plates and ESA unit are disposed.

24. The electrocoagulation system of claim 23, wherein the electrolytic plates are fabricated from material selected from the group consisting of iron, titanium, platinum, steel, aluminum, copper, carbon, metal-impregnated plastics, ceramics or a mixture thereof.

25. The electrocoagulation system of claim 23, wherein the electrolytic plates are made of aluminum.

26. The electrocoagulation system of claim 23, the electrolytic plates are made of iron.

27. The electrocoagulation system of claim 23, the electrolytic plates are made of carbon.

28. The electrocoagulation system of claim 23, wherein each of the electrolytic plates has a hole allowing the aqueous fluids to pass through from one cell to another; wherein the holes on two adjacent plates are opposite cross the center.

29. The electrocoagulation system of claim 23, wherein all the anode electrode plates are connected to one bus-bar and connected to the positive terminal of a DC power supply; and wherein all the cathode electrode plates are connected to another bus-bar and connected to the negative terminal of the DC power supply.

30. The electrocoagulation system of claim 23, wherein the bus-bar is made of copper or copper coated or plated with tin, silver or gold.

31. The electrocoagulation system of claim 23, wherein the ESA unit further comprises:
a speed reduction gearbox;
an electric motor for driving the wiper drive shaft via the speed reduction gearbox;
a bearing with seal for holding the wiper drive shaft in place and allowing smooth movement and water tight sealing; and
a plurality of wiper spacers for insulating the wiper shaft from the electrode plates when the driver shaft penetrates the electrode plates; wherein the driver shaft is disposed through the centers of the electrode plates.

32. The electrocoagulation system of claim 23, wherein the wiper blade has a cylindrical shape.

33. The electrocoagulation system of claim 23, wherein the wiper blade has a partial cylindrical shape with two straight sides.

34. The electrocoagulation system of claim 23, wherein the wiper blade has a thin blade protrusion throughout the length of the blade.

35. The electrocoagulation system of claim 23, wherein the wiper blade has brushes (toothbrush style) attached throughout the length of the blade; wherein the wiper blade further comprises a plurality of holes on its two surfaces facing the plate surfaces to accommodate fibers to form a brush on each side.

36. The electrocoagulation system of claim 23, wherein the sealed chamber is formed by two end bracket/stand, two end insulators, a plurality of electrode plates and a plurality of electrode spacers with O-rings so that the reactions can be carried in a sealed environment, preventing leakage of liquid and gases.

37. The electrocoagulation system of claim 23, further comprises an inlet and an outlet for allowing the EC device to get the aqueous fluids for treatment and exit the treated aqueous fluids.

38. The electrocoagulation system of claim 23, wherein all anode electrode plates are sacrificial so as to form an electro-coagulation device.

39. The electrocoagulation system of claim 23, wherein all anode electrode plates are not sacrificial so as to form an electro-catalytic device.

40. The electrocoagulation system of claim 23, wherein at least one anode electrode plate is different from the rest (e.g., sacrificial vs non-sacrificial) so as to form a hybrid EC device.

41. The electrocoagulation system of claim 23, wherein the aqueous fluids with contaminants are any aqueous solution that needs to be treated before its use.

42. The electrocoagulation system of claim 23, wherein the contaminants include organics, metals, microorganisms, and sub-micro particles.

43. The electrocoagulation system of claim 23, wherein the electrode plates are mounted vertically within the sealed chamber when the device is mounted horizontally.

44. The electrocoagulation system of claim 23, wherein the electrode plates are mounted horizontally within the sealed chamber when the device is mounted vertically.

45. A process for treating aqueous fluids with contaminants, comprising:
providing an electrocoagulation device with a plurality of electrolysis cells, wherein each electrolysis cell is comprised of an anode electrode plate and a cathode electrode plate, and it will cause electrolysis reactions when a power supply is provided;
introducing the aqueous fluids into the electrocoagulation device, wherein the aqueous fluids undergo electrolysis reactions; and
providing a means for minimizing the passivation of the electrode plates, wherein the means comprises a wiper that is in close proximity to the surfaces of the electrode plates and operable to rotate for generating hydraulic flow against the surfaces of the electrode plates.
